(19) United States
(12) Patent Application Publication
(10) Pub. No.: US 2006/0210857 A1
(43) Pub. Date: Sep. 21, 2006

(54) Electrochemical cell arrangement with improved mea-coolant manifold isolation

(76) Inventors: David Frank, Scarborough (CA); Nathaniel Ian Joos, Toronto (CA)

Correspondence Address: BERESKIN AND PARR, 40 KING STREET WEST, BOX 401, TORONTO, ON, M5H 3Y2, CA

(21) Appl. No.: 11/079,094

(22) Filed: Mar. 15, 2005

(51) Int. Cl. H01M 8/10; H01M 8/04; H01M 2/08; H01M 8/02

(52) U.S. Cl. 429/30; 429/26; 429/35; 429/38

(57) ABSTRACT

Typically a seal is arranged around each coolant manifold aperture on each plate included in an electrochemical cell stack. However, each coolant seal is susceptible to failure. Coolant leakage from a failed coolant seal around a coolant manifold aperture on a MEA sheet can be extremely harmful because, in many cases, the coolant is corrosive to the electrolyte layer included on the MEA sheet. By contrast, in some embodiments of the invention, coolant manifold apertures are not included on MEA sheets/sheets in order to further isolate respective the electrolyte layers from coolant flowing through an electrochemical cell stack during operation. Further, in some very specific embodiments seals provided around respective coolant manifolds on corresponding anode and cathode flow field plates are made thicker, than in other areas around the corresponding anode and cathode flow field plates, to accommodate and fill the extra space left over by the absence of coolant manifold apertures and material there around on the MEA sheets.

### FIELD OF THE INVENTION

The invention relates to electrochemical cells, and, in particular to various arrangements of seals and plates suited for use therein.

### BACKGROUND OF THE INVENTION

An electrochemical cell, as defined herein, is an electrochemical reactor that may be configured as either a fuel cell or an electrolyzer cell. Generally, electrochemical cells of both varieties include an anode electrode, a cathode electrode and an electrolyte layer (e.g. a Proton Exchange Membrane) arranged between the anode and cathode electrodes. The various elements of each electrochemical cell are commonly provided in a planar form, such as a plate or sheet-like layer. For example, the electrolyte layer, including for example a Proton Exchange Membrane (PEM), is commonly provided as a very thin Membrane Electrode Assembly (MEA) sheet. Similarly, the anode and cathode electrodes are commonly provided in the form of flow field plates. As such, hereinafter it is to be understood that the designations “front surface” and “rear surface” indicate the orientation of a particular flow field plate with respect to a MEA sheet. The “front surface” refers to an active surface facing a MEA sheet, whereas, the “rear surface” refers to a non-active surface facing away from the MEA sheet.

Fuel cell reactions and electrolysis reactions are typically exothermic and temperature regulation is an important consideration. Adequate temperature regulation provides a control point for the regulation of the desired electrochemical reactions. It is often necessary to provide a separate coolant stream that flows through coolant flow field channels, arranged on the rear surfaces of the constituent flow field plates, to dissipate the heat generated during operation.

Coolant, along with other process gases/fluids, are supplied to and evacuated from the appropriate sides of the plates through respective manifold apertures arranged on each of the plates included. in an electrochemical cell stack. That is, the flow field plates and the MEA sheets typically each have a respective number of manifold apertures. In the specific case of a fuel cell, the corresponding manifold apertures, for each type of coolant and process gas/fluid, on all of the aforementioned plates and sheets align to form respective elongate inlet and outlet channels for an oxidant stream, a coolant stream, and a fuel stream. For example, each type of plate (or sheet) will have a respective manifold aperture for a coolant inlet stream that aligns with other respective manifold apertures for the coolant inlet stream on all the other types of plates.

Typically a seal is arranged around each manifold aperture on each plate, thereby preventing the mixing of coolant and various process gases/fluids with one another. However, individual seals are susceptible to failure, which is a problem that is compounded in an electrochemical cell stack including a large number of individual cells, and thus, an even larger number of individual seals. In particular, coolant leakage from the seal around a coolant manifold aperture on a MEA sheet can be extremely harmful because, in many cases, the coolant is corrosive to the electrolyte layer included on the MEA sheet. One failed MEA sheet in an electrochemical cell stack, containing many MEA sheets, can in turn cause the failure of the entire electrochemical cell stack.

### SUMMARY OF THE INVENTION

According to an aspect of an embodiment of the invention there is provided a membrane electrode assembly having: a solid sheet or electrolyte membrane formed from a material that promotes passage of protons through the membrane; an active area of the membrane, the active area including a catalyst layer on at least one side thereof; a non-active perimeter area surrounding the active area, the non-active perimeter area having an outside edge defining at least one notch corresponding to the placement of a coolant manifold aperture in a flow field plate of an electrochemical cell.

In some embodiments the outside edge defines first and second notches corresponding to the placement of respective first and second coolant manifold apertures in the plate of an electrochemical cell.

In some embodiments the area of each of the first and second notches defined by the outside edge is larger than the cross-sectional area of the first and second coolant manifold apertures, respectively, so as to provide a clearance area, between the edges of the coolant manifold apertures and the outside edge of the non-active perimeter area, at least large enough for seals around the coolant manifold apertures. In some very specific embodiments, the membrane electrode assembly is generally rectangular, and wherein the first notch is provided in the middle of one side of the rectangle, and the second notch is provided in the middle of another, opposite side of the rectangle. In some such embodiments, the non-active perimeter area includes two general rectangular tab areas on either side of the first notch, two generally rectangular tab areas on the other side of the second notch, and wherein there is an active area, that is generally rectangular and located between the first and second notches.

According to another aspect of an embodiment of the invention there is provided a membrane electrode assembly including: a solid sheet or electrolyte membrane formed from a material that promotes passage of protons through the membrane; an; active area of the membrane, the active area including a catalyst layer on at least one side thereof; a non-active perimeter. area surrounding the active area, the non-active perimeter area having at least one tab area defining a first pair of apertures for one reactant and a second pair of apertures for another reactant; and an outside edge defining an omitted portion of the membrane electrode assembly corresponding to coolant apertures of flow field plates of an eletrochemical cell, whereby in use, the membrane electrode assembly is assembled between the flow field plates of the eletrochemical cell, with the first and second pairs of apertures aligned with apertures in the flow field plates to define manifolds for the reactant gases, the flow field plates including coolant apertures aligned and sealed relative to one another with the outside edge of the membrane electrode assembly spaced from said coolant apertures.

In some embodiments the MEA inlcudes at least one first tab potion of one end thereof, including two apertures for the reactant gases, and at least one tab portion at the other end thereof, including two apertures for the reactant gases.

According to an aspect of an embodiment of the invention there is provided an electrochemical cell having: a first flow field plate having a first coolant manifold aperture; a second flow field plate having a first coolant manifold aperture, the two first coolant manifold apertures being aligned to form a portion of a elongate coolant duct; and a membrane electrode assembly arranged between the first and second flow field plates, the membrane electrode assembly having an outer area and having a non-active perimeter area around the active area, with an outside edge extending spaced apart from the coolant manifold apertures. In some specific embodiments each of the first and second flow field plates includes a second coolant manifold aperture, wherein the outside edge of the membrane electrode assembly includes another portion spaced apart from the second coolant manifold apertures. In yet even more specific embodiments, each of the first and second flow field plates includes an active area corresponding to the active area of the membrane electrode assembly, wherein a first active area seal is provided between the first flow field plate and the membrane electrode assembly, to seal the active area of the first flow field plate, wherein a second active area seal is provided between the second flow field plate and the membrane electrode assembly, to seal the active area of the second flow field plate, and a separate first coolant seal is provided between the first and second flow field plates and around the first coolant apertures and a separate second coolant seal is provided between the first and second flow field plates and around the second coolant apertures. Optionally, each of the first and second flow field plates includes two first reactant manifold apertures, aligned to form two pairs of first reactant manifold apertures, and wherein a respective first reactant seal is provided around each pair of aligned first reactant manifold apertures. Additionally, wherein the membrane electrode assembly may include at least one tab portion extending around each pair of aligned first reactant manifold apertures, and wherein each first reactant seal comprises one first reactant seal between the first flow field plate and the membrane electrode assembly and another first reactant seal between the second flow field plate and the membrane electrode assembly. Further, in some very specific embodiments the first active area seal is integral with said one first reactant seal and the second active area seal is integral with said another first reactant seal.

Alternatively, each of the first and second flow field plates includes two second reactant manifold apertures, the second reactant manifold apertures being aligned to form two pairs of aligned apertures, and wherein a respective second reactant seal is provided around each pair of aligned second reactant manifold apertures. In some other very specific embodiments, the membrane electrode assembly includes at least one tab portion extending between the first and second flow field plates and around the aligned pairs of first and second reactant manifold apertures, and wherein each first reactant seal comprises one first reactant seal between the first flow field plate and the membrane electrode assembly and another first reactant seal between the second flow field plate and the membrane electrode assembly, and wherein each second reactant seal comprises one second reactant seal between the first flow field plate and the membrane electrode assembly and another second reactant seal between the second flow field plate and the electrode membrane assembly. Additionally, said one first and second reactant seals are integral with the first active area seal and said another first and second reactant seals are integral with the second active area seal.

In some embodiments each of the first and second coolant seals includes a groove provided in one of the first and second flow field plates around a respective one of the first and second coolant manifold apertures, with a seal therein. Optionally, each of the first and second coolant seals comprises a groove in the first flow field plate around the respective one of the first and second coolant manifold apertures and a seal therein, and a groove in the second flow field plate around a respective one of the first and second coolant manifold apertures with a seal therein.

In some embodiments the first coolant seal comprises: grooves around the first coolant manifold apertures, with one first coolant seal in the groove of the first flow field plate, and another first coolant seal in the groove of the second flow field plate; wherein the second coolant seal comprises grooves in the first or second flow field plates around the second coolant manifold apertures, with one second coolant seal in the groove of the first flow field plate and another second coolant seal in the groove of the second flow field plate, wherein the first flow field plate includes a groove for the first active area seal and the second flow field plate includes a groove for the second active area seal, wherein said one and said another first and second coolant seals have a height higher than said one and said another first and second reactant seals, to allow for the thickness of the membrane electrode assembly.

In some embodiments the height of the said one and said another first and second coolant seals comprises providing grooves around the first and second coolant apertures of the same depth as the grooves around the first and second reactant manifold apertures, and seals for said one and said another first and second coolant apertures with a greater height than seals around the first and second reactant manifold apertures.

According to an aspect of an embodiment of the invention there is provided an electrochemical cell flow field plate comprising: a coolant manifold aperture; an active area; a first sealing surface groove around the coolant manifold aperture; a second sealing surface groove around the active area; a first seal in the first sealing surface groove, defining a first seal height in combination with the first sealing surface groove; and a second seal in the second sealing surface groove, defining a second seal height with the second sealing surface groove, wherein the first seal height is greater than the second seal height.

In some embodiments, the first sealing surface groove has a shallower depth than the second sealing surface groove, and wherein the first and second seals have approximately the same thickness. In other embodiments the first sealing surface groove has approximately the same depth as the second sealing surface groove, and wherein the first seal is somewhat thicker than the second seal.

In some embodiments the electrochemical flow field plate also includes a bridging seal groove, connecting the first and second sealing surface grooves, that is sloped toward the first sealing surface groove. In some embodiments the first seal is formed from a material compatible with a reactant gas used in the electrochemical cell and the second seal is formed from a material compatible with a coolant to be used with the electrochemical cell.

Other aspects and features of the present invention will become apparent, to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1 is a simplified schematic drawing of a fuel cell module;

FIG. 2 is an exploded perspective view of a fuel cell module;

FIG. 3A is an exploded view of an anode flow field plate, a Membrane Electrode Assembly (MEA) sheet and a cathode flow field plate according to aspects of an embodiment of the invention that is suitable for use in the fuel cell module illustrated in FIG. 2;

FIG. 3B is a schematic drawing of the bottom active surface of the cathode flow field plate illustrated in FIG. 3A;

FIG. 3C is a schematic drawing of the top active surface of the anode flow field plate illustrated in FIG. 3A;

FIG. 3D is a schematic drawing showing an enlarged portion of the top active surface of the anode flow field plate illustrated in FIG. 3C;

FIG. 3E is an illustration showing a cross-sectional view taken along line C-C in FIG. 3D;

FIG. 3F is a schematic plan drawing of the MEA sheet shown in FIG. 3A;

FIG. 4A is an illustration showing exploded cross-sectional view of an active seal according to an embodiment of the invention;

FIG. 4B is an illustration showing exploded cross-sectional view of a coolant seal according to an embodiment of the invention;

FIG. 5A is an illustration showing assembled cross-sectional view of the active seal shown in FIG. 4A; and

FIG. 5B is an illustration showing assembled cross-sectional view of the coolant seal shown in FIG. 4B.

### DETAILED DESCRIPTION OF THE INVENTION

Respective coolant manifold apertures are provided on each plate in an electrochemical cell stack to supply and evacuate coolant to the rear surfaces of flow field plates included in the electrochemical cell stack. Typically a seal is arranged around each coolant manifold aperture on each plate included in an electrochemical cell stack. The seals are intended to prevent the mixing of coolant with the various process gases/fluids and to isolate the coolant flow from the electrolyte layer (e.g. a Proton Exchange Membrane) on each Membrane Electrode Assembly (MEA) sheet. However, each coolant seal is susceptible to failure. Coolant leakage from a failed coolant seal around a coolant manifold aperture on a MEA sheet can be extremely harmful because, in many cases, the coolant is corrosive to the electrolyte layer included on the MEA sheet. One failed MEA sheet in an electrochemical cell stack, containing many MEA sheets, can in turn, cause the failure of the entire electrochemical cell stack.

By contrast, in some embodiments of the invention, coolant manifold apertures are not included on MEA sheets in order to further isolate respective the electrolyte layers from coolant flowing through an electrochemical cell stack during operation. Further, in some very specific embodiments seals provided around respective coolant manifolds on corresponding anode and cathode flow field plates are made thicker, than in other areas around the corresponding anode and cathode flow field plates, to accommodate and fill the extra space left over by the absence of coolant manifold apertures and material there around on the MEA sheets. Alternatively and/or additionally, the corresponding front surfaces of the anode and cathode flow field plates can be provided with sealing surfaces of varying depth around the respective coolant manifold apertures to accommodate and fill the extra space left over by the absence of coolant manifold apertures and material there around on the MEA sheets.

Aspects of flow field structures and plate arrangements according to examples described in the applicant's co-pending U.S. patent application Ser. No. 10/109,002 (filed 29 Mar. 2002) can be employed to provide reduced shearing forces on a membrane and simplify sealing between flow field plates. The entire contents of the applicant's co-pending U.S. patent application Ser. No. 10/109,002 are hereby incorporated by reference.

As disclosed in the applicant's co-pending U.S. patent application Ser. No. 10/109,002, after assembly, a substantial portion of the anode flow field channels and the cathode flow field channels are disposed directly opposite one another with a membrane arranged between the two electrodes. Accordingly, a substantial portion of the ribs of the anode flow field plate match-up with a corresponding substantial portion of the ribs on the cathode flow field plate.

Aspects of flow field plate arrangements according to examples described in the applicant's co-pending U.S. patent application Ser. No. 09/855,018 (filed 15 May 2001) can also be employed to provide an effective sealing between flow field plates and a membrane arranged between the two electrodes. The entire contents of the applicant's co-pending U.S. patent application Ser. No. 09/855,018 are hereby incorporated by reference.

As disclosed in the applicant's co-pending U.S. patent application Ser. No. 09/855,018, the inlet flow of a particular process gas/fluid from a respective manifold aperture does not take place directly over the front (active) surface of a flow field plate; rather, the process gas/fluid is first guided from the respective manifold aperture over a portion of the rear (passive) surface of the flow field plate and then through a “back-side feed” aperture extending from the rear surface to the front surface. A portion of the front surface defines an active area that is sealingly separated from the respective manifold aperture over the front surface when an electrochemical cell stack is assembled. The portion of the rear surface over which the inlet flow of the process gas/fluid takes place has open-faced gas/fluid flow field channels in fluid communication with the respective manifold aperture. The back-side feed apertures extend from the rear surface to the front surface to provide fluid communication between the active area and the open-faced gas/fluid flow field channels that are in fluid communication with the respective manifold aperture. Accordingly, as described in the examples provided in the applicant's co-pending U.S. patent application Ser. No. 09/855,018, a seal between the membrane and the front face flow field plate can be made in an unbroken path around the periphery of the membrane.

In prior art examples, the seal between the membrane and the active area on the front surface of the flow field plate, which is typically around the periphery of the membrane is broken by the open-faced flow field channels leading to the respective manifold aperture from the active area on the front surface of the flow field plate. By contrast, according to the applicant's aforementioned co-pending application a process gas/fluid is fed to the active area on the front surface through back-side feed apertures from the rear surface of each flow field plate, where a seal is made around the back-side feed apertures and the respective manifold aperture(s). This method of flowing fluids from a rear (passive or non-active) surface to the front (active) surface is referred to as “back-side feed” in the description. Those skilled in the art would appreciate that gases/fluids can be evacuated from the active area on the front surface to the rear surface and then into another respective manifold aperture in a similar manner.

Aspects of flow field plate arrangements according to examples described in the applicant's co-pending U.S. patent application Ser. No. 10/845,263 (filed 14 May 2004) can also be employed to provide an effective sealing between flow field plates and a membrane arranged between the two electrodes. The entire contents of the applicant's co-pending U.S. patent application Ser. No. 10/845,263 are hereby incorporated by reference.

As also disclosed in the applicant's co-pending U.S. patent application Ser. No. 10/845,263, the inlet flow of a particular process gas/fluid from a respective manifold aperture does not take place directly over the front (active) surface of a flow field plate; rather, the process gas/fluid is first guided from the respective manifold aperture over a portion of an oppositely facing complementary active surface, belonging to an adjacent electrochemical cell, and then through a “complementary active-side feed” aperture extending through to the front surface of the flow field plate. According to examples described in the applicant's co-pending U.S. patent application Ser. No. 10/845,263 a seal between the membrane and the flow field plate can be made in an unbroken path around the periphery of the membrane, without requiring the flow field plate to have a passive surface, as in the examples described in the applicant's co-pending U.S. patent application Ser. No. 09/855,018.

Aspects of flow field plate arrangements according to examples described in the applicant's co-pending U.S. patent application Ser. No. 10/845,263 provide for a symmetrical flow field plate arrangement that enables the use of a single flow field plate design for both anode and cathode flow field plates employed in an electrochemical cell stack. That is, in some embodiments, the anode and cathode flow field plates employed for use in an electrochemical cell stack are substantially identical.

Also, the “seal-in-place” technique taught in the applicant's co-pending U.S. patent application Ser. No. 09/854,362 could advantageously be used in combination with aspects of embodiments of the present invention. The entire contents of U.S. patent application Ser. No. 09/854,362 are hereby incorporated by reference.

It is commonly understood that in practice a number of electrochemical cells, all of one type, can be arranged in stacks having common features, such as process gas/fluid feeds, drainage, electrical connections and regulation devices. That is, an electrochemical cell module is typically made up of a number of singular electrochemical cells connected in series to form an electrochemical cell stack. The electrochemical cell module also includes a suitable combination of associated structural elements, mechanical systems, hardware, firmware and software that is employed to support the function and operation of the electrochemical cell module. Such items include, without limitation, piping, sensors, regulators, current collectors, seals, insulators and electromechanical controllers.

As noted above, flow field plates typically include a number of manifold apertures that each serve as a portion of a corresponding elongate distribution channel for a particular process gas/fluid. In some embodiments, the cathode of an electrolyzer cell does not need to be supplied with an input process gas/fluid and only hydrogen gas and water need to be evacuated from it. In such electrolyzer cells a flow field plate does not require an input manifold aperture for the cathode but does require an output manifold aperture. By contrast, a typical embodiment of a fuel cell makes use of inlet and outlet manifold apertures for both the anode and the cathode. However, a fuel cell can also be operated in a dead-end mode in which process reactants are supplied to the fuel cell but not circulated away from the fuel cell. In such embodiments, only inlet manifold apertures are provided.

There are a number of different electrochemical cell technologies and, in general, this invention is expected to be applicable to all types of electrochemical cells. Very specific example embodiments of the invention have been developed for use with Proton Exchange Membrane (PEM) fuel cells. Other types of fuel cells include, without limitation, Alkaline Fuel Cells (AFC), Direct Methanol Fuel Cells (DMFC), Molten Carbonate Fuel Cells (MCFC), Phosphoric Acid Fuel Cells (PAFC), Solid Oxide Fuel Cells (SOFC) and Regenerative Fuel Cells (RFC). Similarly, other types of electrolyzer cells include, without limitation, Solid Polymer Water Electrolyzer (SPWE).

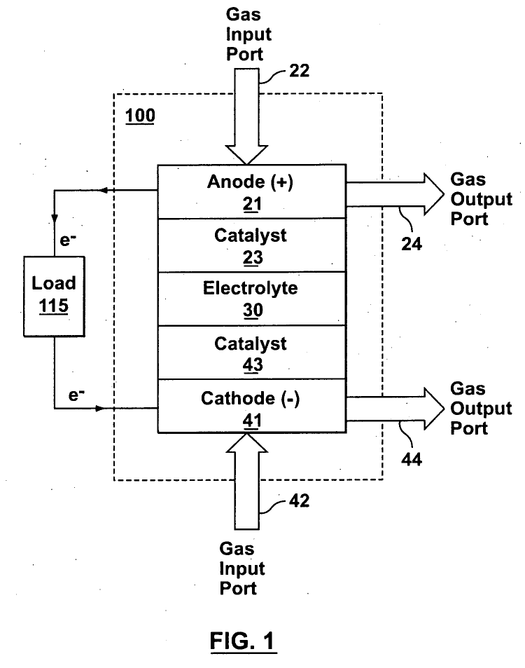

Referring to FIG. 1, shown is a simplified schematic diagram of a Proton Exchange Membrane (PEM) fuel cell module, simply referred to as fuel cell module 100 hereinafter, that is described herein to illustrate some general considerations relating to the operation of electrochemical cell modules. It is to be understood that the present invention is applicable to various configurations of electrochemical cell modules that each include one or more electrochemical cells. Those skilled in the art would appreciate that a PEM electrolyzer module has a similar configuration to the PEM fuel cell module 100 shown in FIG. 1.

The fuel cell module 100 includes an anode electrode 21 and a cathode electrode 41. The anode electrode 21 includes a gas input port 22 and a gas output port 24. Similarly, the cathode electrode 41 includes a gas input port 42 and a gas output port 44. An electrolyte membrane 30 is arranged between the anode electrode 21 and the cathode electrode 41.

The fuel cell module 100 also includes a first catalyst layer 23 between the anode electrode 21 and the electrolyte membrane 30, and a second catalyst layer 43 between the cathode electrode 41 and the electrolyte membrane 30. In some embodiments the first and second catalyst layers 23, 43 are directly deposited on the anode and cathode electrodes 21, 41, respectively.

A load 115 is connectable between the anode electrode 21 and the cathode electrode 41.

In operation, hydrogen fuel is introduced into the anode electrode 21 via the gas input port 22 under some predetermined conditions. Examples of the predetermined conditions include, without limitation, factors such as flow rate, temperature, pressure, relative humidity and a mixture of the hydrogen with other gases. The hydrogen reacts electrochemically according to reaction (1), given below, in the presence of the electrolyte membrane 30 and the first catalyst layer. 23.
H₂→2H⁺+2e⁻ (1)
The chemical products of reaction (1) are hydrogen ions (i.e. cations) and electrons. The hydrogen ions pass through the electrolyte membrane 30 to the cathode electrode 41 while the electrons are drawn through the load 115. Excess hydrogen (sometimes in combination with other gases and/or fluids) is drawn out through the gas output port 24.

Simultaneously an oxidant, such as oxygen in the air, is introduced into the cathode electrode 41 via the gas input port 42 under some. predetermined conditions. Examples of the predetermined conditions include, without limitation, factors such as flow rate, temperature, pressure, relative humidity and a mixture of the oxidant with other gases. The excess gases, including the unreacted oxidant and the generated water are drawn out of the cathode electrode 41 through the gas output port 44.

The oxidant reacts electrochemically according to reaction (2), given below, in the presence of the electrolyte membrane 30 and the second catalyst layer 43.
1/2O₂+2H⁺+2e⁻→H₂ (2)

The chemical product of reaction (2) is water. The electrons and the ionized hydrogen atoms, produced by reaction (1) in the anode electrode 21, are electrochemically consumed in reaction (2) in the cathode electrode 41. The electrochemical reactions (1) and (2) are complementary to one another and show that for each oxygen molecule (O₂) that is electrochemically consumed two hydrogen molecules (H₂) are electrochemically consumed.

In a similarly configured water supplied electrolyzer the reactions (2) and (1) are respectively reversed in the anode and cathode. This is accomplished by replacing the load 115 with a voltage source and supplying water to at least one of the two electrodes. The voltage source is used to apply an electric potential that is of an opposite polarity to that shown on the anode and cathode electrodes 21 and 41, respectively, of FIG. 1. The products of such an electrolyzer include hydrogen (H₂) and oxygen (O₂).

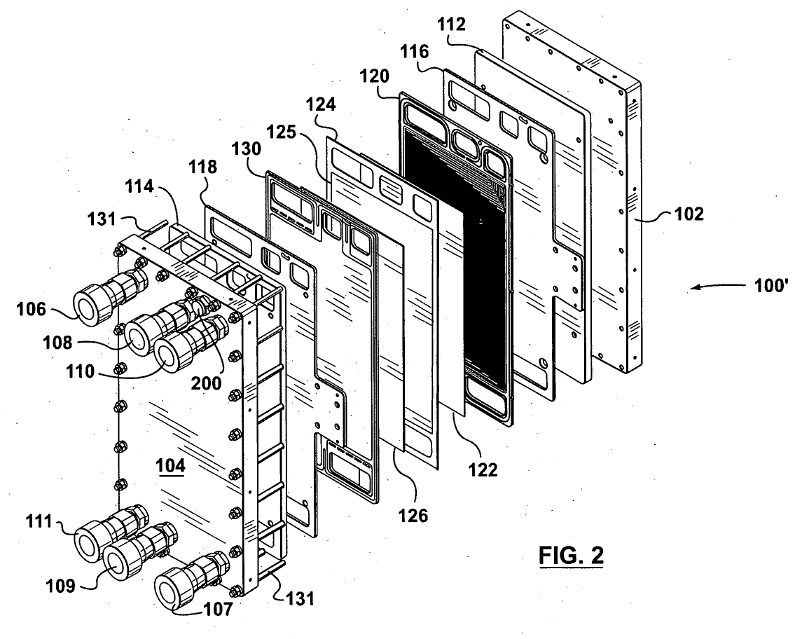

Referring now to FIG. 2, illustrated is an exploded perspective view of a fuel cell module 100′. For the sake of brevity and simplicity, only the elements of one electrochemical cell are shown in FIG. 2. That is, the fuel cell module 100′ includes only one fuel cell; however, a fuel cell stack will usually include a number of fuel cells stacked together and electrically connected in series. The fuel cell of the fuel cell module 100′ comprises an anode flow field plate 120, a cathode flow field plate 130, and a Membrane Electrode Assembly (MEA) 124 arranged between the anode and cathode flow field plates 120, 130. Again, the designations “front surface” and “rear surface” with respect to the anode and cathode flow field plates 120, 130 indicate their respective orientations with respect to the MEA 124. The “front surface” of a flow field plate is the side facing towards the MEA 124, while the “rear surface” faces away from the MEA 124.

Briefly, each flow field plate 120, 130 has an inlet region and an outlet region. In this particular embodiment, for the sake of clarity, the inlet and outlet regions are placed on opposite ends of each flow field plate, respectively. However, various other arrangements are also possible. Each flow field plate 120, 130 also includes a number of open-faced flow channels that fluidly connect the inlet to the outlet regions and provide a structure for distributing the process gases/fluids to the MEA 124.

The MEA 124 includes a solid electrolyte (e.g. a proton exchange membrane) 125 arranged between an anode catalyst layer (not shown) and a cathode catalyst layer (not shown). As noted earlier, coolant supplied to the fuel cell module 100′ during operation may be corrosive to the solid electrolyte 125 included in the MEA 124.

The fuel cell of the fuel cell module 100′ includes a first Gas Diffusion Media (GDM) 122 that is arranged between the anode catalyst layer and the anode flow field plate 120, and a second GDM 126 that is arranged between the cathode catalyst layer and the cathode flow field plate 130. The GDMs 122, 126 facilitate the diffusion of the process gases (e.g. fuel, oxidant, etc.) to the catalyst surfaces of the MEA 124. The GDMs 122, 126 also enhance the electrical conductivity between each of the anode and cathode flow field plates 120, 130 and the solid electrolyte 125 (e.g. a proton exchange membrane).

The elements of the fuel cell are enclosed by supporting elements of the fuel cell module 100′. Specifically, the fuel cell module 100′ includes an anode endplate 102 and a cathode endplate 104, between which the fuel cell and other elements are appropriately arranged. In the present embodiment the cathode endplate 104 is provided with connection ports for supply and removal of process gases/fluids. The connection ports will be described in greater detail below.

Other elements arranged between the anode and cathode endplates 102, 104 include an anode insulator plate 112, an anode current collector plate 116, a cathode current collector plate 118 and a cathode insulator plate 114, respectively. In different embodiments varying numbers of electrochemical cells are arranged between the current collector plates 116 and 118. In such embodiments the elements that make up each electrochemical cell are appropriately repeated in sequence to provide an electrochemical cell stack that produces a desired output.

In order to hold the fuel cell module 100′ together tie rods 131 are provided that are screwed into threaded bores in the anode endplate 102 (or otherwise fastened), passing through corresponding plain bores in the cathode endplate 104. Nuts and washers (or other fastening means) are provided for tightening the whole assembly and to ensure that the various elements of the individual electrochemical cells are held together. The tie rods 131 and the respective fastening means are used to apply pressure to the end plates 102 and 104 to hold all of the aforementioned plates of the electrochemical cell 100′ together in a sealing arrangement.

As noted above various connection ports to an electrochemical cell stack are included to provide a means for supplying and evacuating process gases, fluids, coolants etc. In some embodiments the various connection ports to an electrochemical cell stack are provided in pairs. One of each pair of connection ports is arranged on a cathode endplate (e.g. cathode endplate 104) and the other is appropriately placed on an anode endplate (e.g. anode endplate 102). In other embodiments, the various connection ports are only placed on either the anode or cathode endplate. It will be appreciated by those skilled in the art that various arrangements for the connection ports may be provided in different embodiments of the invention.

With continued reference to FIG. 2, the cathode endplate 104 has first and second air connection ports 106, 107, first and second coolant connection ports 108, 109, and first and second hydrogen connection ports 110, 111. The ports 106-111 are arranged so that they will be in fluid communication with manifold apertures included on the MEA 124, the first and second gas diffusion media 122, 126, the anode and cathode flow field plates 120, 130, the first and second current collector plates 116, 118, and the first and second insulator plates 112, 114. The manifold apertures on all of the aforementioned plates align to form respective elongate inlet and outlet channels for an oxidant stream, a coolant stream, and a fuel stream. By contrast, in some embodiments of the invention manifold apertures for the coolant stream are not provided on the MEA sheets.

The fuel cell module 100′ is operable to facilitate a catalyzed reaction once supplied with the appropriate process gases/fluids under the appropriate conditions. In such a catalyzed reaction, a fuel, such as hydrogen, is oxidized at the anode catalyst layer of the MEA 124 to form protons and electrons. The solid electrolyte (e.g. proton exchange membrane) 125 facilitates migration of the protons from the anode catalyst layer to the cathode catalyst layer. Most of the free electrons will not pass through the solid electrolyte 125, and instead flow through an external circuit (e.g. load 115 in FIG. 1) via the current collector plates 116, 118, thus providing an electrical current. At the cathode catalyst layer of the MEA 124, oxygen reacts with electrons returned from the electrical circuit to form anions. The anions formed at the cathode catalyst layer of the MEA 124 react with the protons that have crossed the solid electrolyte 125 to form liquid water as the reaction product.

Simultaneously, a coolant stream through the fuel cell module 100′ is provided to the fuel cell(s) via connection ports 108, 109 and coolant manifold apertures in the aforementioned plates. As the fuel cell reaction is exothermic and the reaction rate is sensitive to temperature, the flow of coolant takes away the heat generated in the fuel cell reaction, preventing the temperature of the fuel cell stack from increasing, thereby regulating the fuel cell reaction at a stable level. The coolant is a gas or fluid that is capable of providing a sufficient heat exchange that will permit cooling of the stack. Examples of known coolants include, without limitation, water, de-ionized water, oil, ethylene glycol, and propylene glycol.

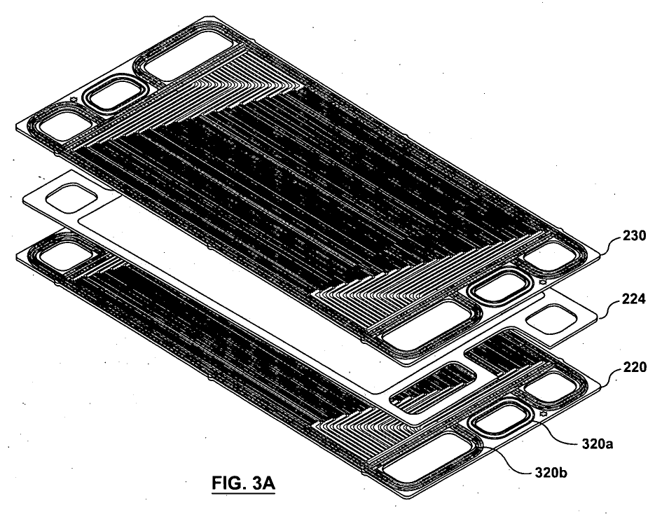

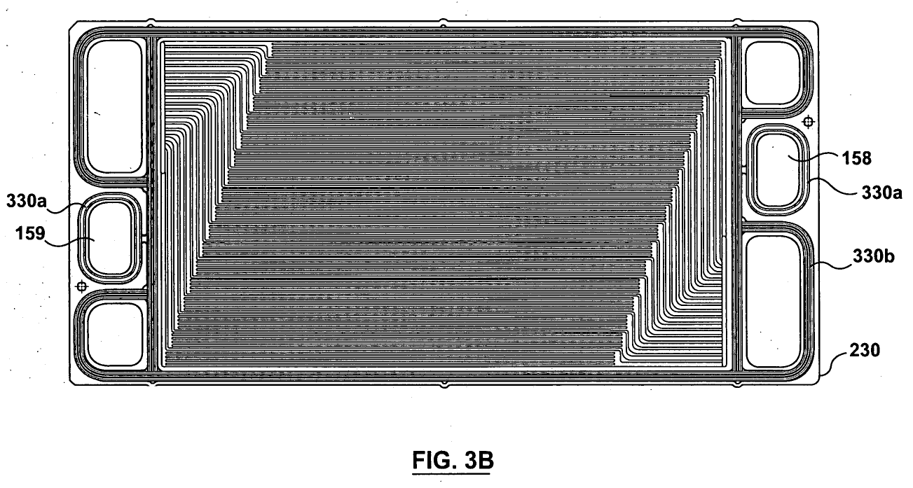

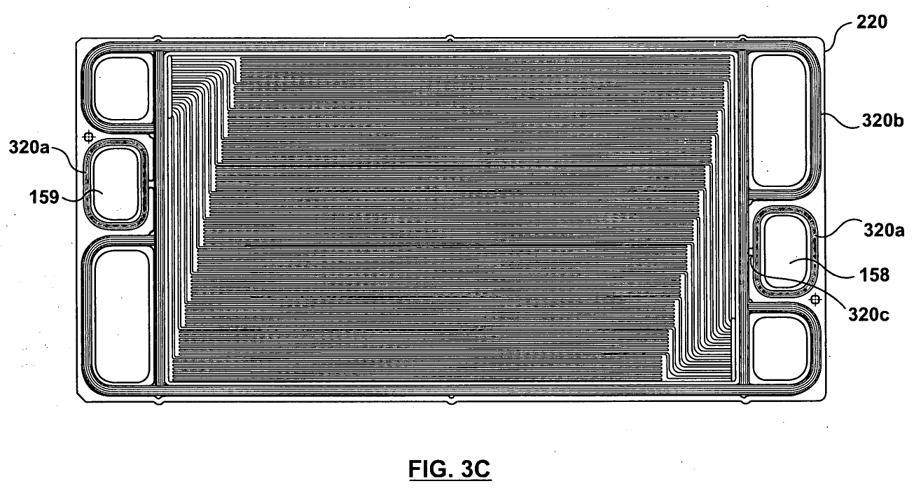

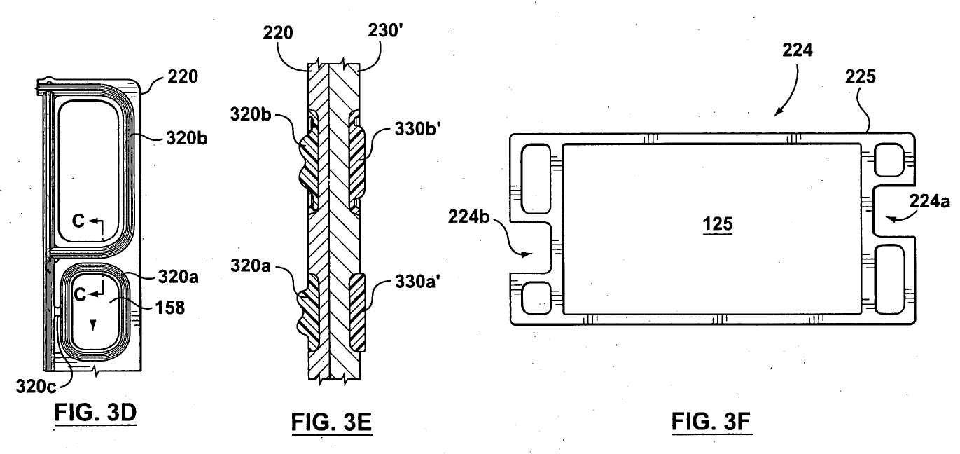

It was noted above that varying numbers of electrochemical cells can be arranged between the current collector plates 116 and 118, shown in FIG. 2, to provide an electrochemical cell stack that produces a desired output. As such, a repeatable number of elements that make up each electrochemical cell are appropriately repeated in sequence to provide an electrochemical cell stack that produces a desired output. To that end, FIG. 3A shows an exploded view of an anode flow field plate 220, a MEA sheet 224 and a cathode flow field plate 230, that are suitable for use in an electrochemical cell according to an embodiment of the invention.

In this very specific embodiment, the anode and cathode flow field plates 220 and 230 are identical to one another as described in the applicant's co-pending U.S. patent application Ser. No. 10/845,263, incorporated by reference above, and are bonded together to form a bipolar plate. In particular, each plate 220 and 230 includes two constituent flow field plates, each having an active front surface and a passive rear surface, that are bonded to one another back-to-back (i.e. rear surface to rear surface) to form a bipolar flow field plate. Coolant channels can be provided on the back of one or both of the two constituent flow field plates.

More specifically, FIG. 3A schematically shows a portion of the top surface of the anode flow field plate 220 and the top surface of the cathode flow field plate 230. The MEA sheet 224, having the solid electrolyte layer 125 (as described above), is arranged in a complete fuel cell between the anode and cathode flow field plates 220, 230. Each such fuel cell will be formed between a pair of bipolar plates, each comprising a pair of anode and cathode flow field plates 220 and 230. The front active face of the cathode flow field plate 230, shown in FIG. 3B, of one bipolar plate is the active cathode surface for the electrochemical cell shown in FIG. 3A; similarly, the top of another bipolar plate of the anode flow field plate 220, shown in FIGS. 3A and 3C, is the active anode surface for the electrochemical cell shown in FIG. 3A.

In FIG. 3A, the respective bottom and top surfaces of the anode and cathode flow field plates 220 and 230 correspond to respective cathode and anode active surfaces for adjacent electrochemical cells, since the combined anode and cathode flow field plates 220 and 230 form a bipolar flow field plate, with coolant flow channels traversing the center of each bipolar plate along rear passive surfaces, as described in the applicant's co-pending application [Attorney Ref No.: 9351-679] filed on the same day as this application, the contents of which are hereby incorporated by reference.

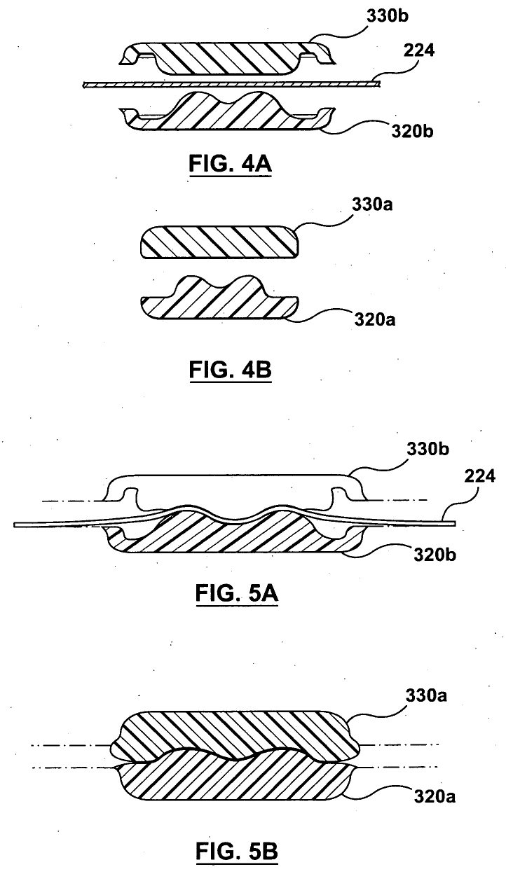

Referring to FIGS. 3B and 3C, provided are schematic plan views of the front active surfaces of the cathode and anode flow field plates 230 and 220, respectively. Each of the anode and cathode flow field plates 220 and 230 have respective coolant manifold apertures 158 and 159 that align to form respective elongate inlet and outlet channels for a coolant stream. On the anode flow field plate 220 a seal 320a is provided around the coolant manifold apertures 158 and 159, and a seal 320b is provided around the active area and other manifold apertures. Similarly, on the cathode flow field plate a seal 330a is provided around the coolant manifold apertures 158 and 159, and a seal 330b is provided around the active area and other manifold apertures. In some embodiments the seals 320a and 320b are complementary to corresponding seals 330a and 330b, respectively. Specifically, the seals 320a and 320b are designed to mate with the corresponding seals 330a and 330b in respective sealing engagement. A very specific embodiment of the sealing engagement between seals 320b and 330b will be described in more detail below with reference to FIGS. 4A and 5A. Similarly, a very specific embodiment of the sealing engagement between seals 320a and 330a will be described in more detail below with reference to FIGS. 4B and 5B.

A respective sealing surface groove is provided directly beneath the seals 320a and 320b on the anode flow field plate 220. Similarly, another sealing surface groove is provided directly beneath the seals 330a and 330b. In this particular embodiment, the sealing surface groove is meant to completely separate the inlet and outlet manifold apertures from one another and the respective flow fields on the anode and cathode flow field plates 220 and 230. In some embodiments, the sealing surface may have a varied depth (in the direction perpendicular to the plane of FIGS. 3B-3C) and/or width.

Referring now to FIG. 3D, in some embodiments a bridging seal groove is provided to connect the seal 320a to the seal 320b, with a corresponding seal 320c. The bridging seal groove is sloped toward the seal 320a to prevent leaked coolant from flowing towards the seal 320b. Similar bridging seal grooves can be provided around other coolant manifold apertures as well, such as for connecting the seal 330a to the seal 330b, and further details are set out below.

With continued reference to FIG. 3D shown is a schematic drawing of an enlarged portion of the top surface of the anode flow field plate around the coolant manifold aperture 158 and an adjacent manifold aperture 156. With additional reference to FIG. 3E illustrated is a cross-sectional view taken along line C-C in FIG. 3D, which extends from the manifold aperture 156, through the seals 320b , 330b (not shown in FIG. 3D), 320a and 330a (not shown in FIG. 3D) of a bipolar plate. The bipolar plate shown in FIG. 3E comprises an anode flow field plate 220 and a cathode flow field plate indicated at 230′ assembled as described with the rear, passive faces abutting one another. Moreover, coolant flows between the rear faces of the plates 220 and 230′ of one bipolar plate. The seals 320a and 330a′ are placed on opposite sides of the same bipolar plate around the coolant manifold aperture 158. Similarly, the seals 320b and 330b′ are placed on opposite sides of the same bipolar plate around the other manifolds (e.g. adjacent manifold 156) and the active areas.

A schematic plan view of the MEA 224 is shown in FIG. 3F. The MEA includes a solid electrolyte membrane 125, such as for example a Proton Exchange Membrane (PEM), having a central portion provided with a catalyst layer and a non-active perimeter area 225 surrounding the catalyst layer. Conventional MEAs (e.g. MEA sheet 124 shown in FIG. 2) include manifold apertures for inlet and outlet coolant streams in a non-active perimeter surrounding the catalyst layer. By contrast, in this very specific embodiment of the invention the MEA 224 does not have coolant manifold apertures in the non-active perimeter area 225. Instead, the non-active perimeter area 225 of the MEA 224 has notches 224b and 224b in which material is completely absent in the corresponding areas in and around the coolant manifold apertures 158 and 159 on the anode and cathode flow field plates 220 and 230 described above. That is, with reference to FIGS. 3B-3C and 3F, the non-active perimeter area 225 has an outside edge that defines the notches 224a and 224b corresponding to the placement of the respective coolant manifold apertures 158 and 159 on the anode and cathode flow field plates 220, 230. The lack of any material in these areas reduces the risk that coolant that has leaked can reach the MEA 224.

With further reference to FIGS. 3A-3E, in order to ensure adequate sealing around the coolant manifold apertures 158 and 159 on the anode and cathode flow field plates 220, 230 the seals 320a and 330a are thicker (or higher) than the seals 320b and 330b, by an amount that is approximately equal to the thickness of the MEA 224. Moreover, the area of the notches 224b, 224b defined by the outside edge of the non-active perimeter area 225 is larger than the respective areas of the coolant manifold apertures 158, 159 so as to provide a clearance area, between the edges of each coolant manifold aperture 158, 159 and the outside edge of the non-active perimeter area defining the notches 224b , 224b, that is at least large enough for the seals 320a, 330a to fit around the coolant manifold apertures 158, 159 as described above. In some embodiments, the clearance area is somewhat larger than required to accommodate the seals 320a, 330a, in order to further isolate the MEA 224 from coolant inlet and outlet streams.

For the seals 320a, 330a, the important criteria are the height of the seals 320a, 330a relative to a set plane, such as the top of the front surface of each plate 220, 230. This can be achieved in various ways. For example, the grooves for all the seals 320a, 320b, 330a, 330b can be formed to the same depth, and then the seals 320a, 330a themselves can simply be thicker to provide the necessary extra height, to allow for the missing MEA 124. Note that the additional height or thickness is small, of the order of a few thousandths of an inch, but it has proved critical to obtaining a good seal.

Alternatively, the seals 320a, 320b, 330a, 330b can all be formed with the same thickness, and the bottom of the grooves for the seals 320a, 330a would then be correspondingly raised to give the additional height.

In either cause, as shown at 320c, a bridging seal 320c can be provided when the seals 320a, 320b and/or 330a, 330b are to be formed of the same material. Where the grooves for the seals 320a, 320b 330a, 330b have the same depth, then the groove for seal 320c can simply have the same depth and be flush with them. Where the grooves have different depths, then it will likely be preferable to slope the groove for seal 320c, joining the grooves together, and this will likely not be preferred as it complicates the plate design. In any event, the top of the bridging seal 320c is preferably flush with the face of plate 220. A simple bridging seal (not shown) can be provided between the seals 330a, 330b.

FIGS. 4A and 4B are illustrations of enlarged exploded cross-sectional views of the corresponding active and coolant seals respectively. Specifically, the active seal is illustrated in FIG. 4A and includes the seals 320b and 330b on the corresponding anode and cathode flow field plates 220 and 230, respectively. A portion of the MEA 224 is arranged between the seals 320b and 330b, and is thus included in the active seal. To reiterate, in the very specific embodiment illustrated, the active seal is used to isolate the active area on the flow field plates from the various manifold apertures and provide a sealing means around the manifold apertures, not including the coolant manifold apertures 158 and 159. By contrast, the coolant seal, shown in FIG. 4B includes only the seals 320a and 330a on the corresponding anode and cathode flow field plates 220 and 230. Accordingly, because the coolant seal does not include any portion of the MEA 224, the seals 320a and 330a are made thicker to compensate for the lack of material in order to provide a tight seal. Additionally and/or alternatively, in other embodiments, the thickness of the anode and cathode flow field plates 220 and 230 could be adjusted in the areas around the coolant seal (i.e. the coolant sealing groove) to compensate for the absence of the MEA 224 between the seals 320a and 330a.

FIGS. 5A and 5B are illustrations enlarged assembled cross-sectional views of the corresponding active and coolant seals shown in FIGS. 4A and 4B, respectively. With specific reference to FIG. 5A, after assembly the portion of the MEA 224 between the seals 320b and 330b is compressed in a sealing engagement with the seals 320b and 330b to establish the assembled active seal. As is illustrated, the MEA 224 and the seals 320b and 330b deform somewhat as the active seal is established. Similarly, with specific reference to FIG. 5B, the seals 320a and 330b mate in a sealing engagement and deform somewhat as the coolant seal is established. In contrast to prior art coolant seals, the coolant seal shown herein is directly formed between an anode flow field plate and a cathode flow field plate without a portion of a MEA therebetween.

It will be understood that the seals could have a number of different profiles, except where the sealing technique disclosed in application Ser. No. 09/854,362 is used. Thus, as shown in FIGS. 4A, 4B and FIGS. 5A, 5B, each seal would have either a generally flat surface or a ribbed surface with one, two, or more ribs. Additionally, as shown for seals 320b, 330b, the seals can include side channels to accommodate compression and deformation of each seal, so as to achieve an even sealing pressure, to take into account acceptable tolerances, and to avoid applying too much stress to the flow field plates.

The seals can be molded separately or injection molded in place. When injection molded in place, it is preferred to mold all the seals for one bipolar plate simultaneously, i.e. the seals 320a, 320b and 330a, 330b of the anode and cathode plates 220, 230 making up the bipolar plate. For this purpose, connecting through holes can be provided between the grooves on the two plates 220, 230, to facilitate flow of material during the injection process.

An advantage of the present invention is that a different sealing material can be used for the coolant seals 320a, 330a, and in this case the bridging seals, e.g. seal 320c, would be omitted. The material for seals 320a, 330a can be selected to be compatible with the coolant, and correspondingly the other seals 320b, 330b would be formed from a material selected to be compatible with the reactant gases and provided a good seal. In such a case, it is possible that only one seal or each face is formed by injection molding, although both could be so formed, either separately or, at least to some extent, simultaneously.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention. Numerous modifications and variations of the present invention are possible in light of the above teachings. It is therefore to be understood that within the scope of the appended claims, the invention may be practiced otherwise than as specifically described herein.

We claim:

1. A membrane electrode assembly comprising:
a solid sheet or electrolyte membrane formed from a material that promotes passage of protons through the membrane;
an active area of the membrane, the active area including a catalyst layer on at least one side thereof;
a non-active perimeter area surrounding the active area, the non-active perimeter area having an outside edge defining at least one notch corresponding to the placement of a coolant manifold aperture in a flow field plate of an electrochemical cell.

2. A membrane electrode assembly according to claim 1, wherein the outside edge defines first and second notches corresponding to the placement of respective first and second coolant manifold apertures in the plate of an electrochemical cell.

3. A membrane electrode assembly according to claim 1, wherein the area of each of the first and second notches defined by the outside edge is larger than the cross-sectional area of the first and second coolant manifold apertures, respectively, so as to provide a clearance area, between the edges of the coolant manifold apertures and the outside edge of the non-active perimeter area, at least large enough for seals around the coolant manifold apertures.

4. A membrane electrode assembly as claimed in claim 3, wherein the membrane electrode assembly is generally rectangular, and wherein the first notch is provided in the middle of one side of the rectangle, and the second notch is provided in the middle of another, opposite side of the rectangle.

5. A membrane electrode assembly as claimed in claim 4, wherein the non-active perimeter area includes two general rectangular tab areas on either side of the first notch, two generally rectangular tab areas on the other side of the second notch, and wherein there is an active area, that is generally rectangular and located between the first and second notches.

6. A membrane electrode assembly comprising:
a solid sheet or electrolyte membrane formed from a material that promtes passage of protons through the membrane;
an active area of the membrane, the active area including a catalyst layer on at least one side thereof;
a non-active perimeter area surrounding the active area, the non-active perimeter area having at least one tab area defining a first pair of apertures for one reactant and a second pair of apertures for another reactant; and
an outside edge defining an omitted portion of the membrane electrode assembly corresponding to coolant apertures of flow field plates of an eletrochemical cell, whereby in use, the membrane electrode assembly is assembled between the flow field plates of the eletrochemical cell, with the first and second pairs of apertures aligned with apertures in the flow field plates to define manifolds for the reactant gases, the flow field plates including coolant apertures aligned and sealed relative to one another with the outside edge of the membrane electrode assembly spaced from said coolant apertures.

7. A membrane electrode assembly as claimed in claim 6, including at least one first tab potion of one end thereof, including two apertures for the reactant gases, and at least one tab portion at the other end thereof, including two apertures for the reactant gases.

8. An electrochemical cell comprising:
a first flow field plate having a first coolant manifold aperture;
a second flow field plate having a first coolant manifold aperture, the two first coolant manifold apertures being aligned to form a portion of a elongate coolant duct; and
a membrane electrode assembly arranged between the first and second flow field plates, the membrane electrode assembly having an outer area and having a non-active perimeter area around the active area, with an outside edge extending spaced apart from the coolant manifold apertures.

9. An electrochemical as claimed in claim 8, wherein each of the first and second flow field plates includes a second coolant manifold aperture, wherein the outside edge of the membrane electrode assembly includes another portion spaced apart from the second coolant manifold apertures.

10. An electrochemical cell as claimed in claim 9, wherein each of the first and second flow field plates includes an active area corresponding to the active area of the membrane electrode assembly, wherein a first active area seal is provided between the first flow field plate and the membrane electrode assembly, to seal the active area of the first flow field plate, wherein a second active area seal is provided between the second flow field plate and the membrane electrode assembly, to seal the active area of the second flow field plate, and a separate first coolant seal is provided between the first and second flow field plates and around the first coolant apertures and a separate second coolant seal is provided between the first and second flow field plates and around the second coolant apertures.

11. An electrochemical cell as claimed in claim 10, wherein each of the first and second flow field plates includes two first reactant manifold apertures, aligned to form two pairs of first reactant manifold apertures, and wherein a respective first reactant seal is provided around each pair of aligned first reactant manifold apertures.

12. An electrochemical cell as claimed in claim 11, wherein the membrane electrode assembly includes at least one tab portion extending around each pair of aligned first reactant manifold apertures, and wherein each first reactant seal comprises one first reactant seal between the first flow field plate and the membrane electrode assembly and another first reactant seal between the second flow field plate and the membrane electrode assembly.

13. An electrochemical cell as claimed in claim 12, wherein the first active area seal is integral with said one first reactant seal and the second active area seal is integral with said another first reactant seal.

14. An electrochemical cell as claimed in claim 11, wherein each of the first and second flow field plates includes two second reactant manifold apertures, the second reactant manifold apertures being aligned to form two pairs of aligned apertures, and wherein a respective second reactant seal is provided around each pair of aligned second reactant manifold apertures.

15. An electrochemical cell as claimed in claim 14, wherein the membrane electrode assembly includes at least one tab portion extending between the first and second flow field plates and around the aligned pairs of first and second reactant manifold apertures, and wherein each first reactant seal comprises one first reactant seal between the first flow field plate and the membrane electrode assembly and another first reactant seal between the second flow field plate and the membrane electrode assembly, and wherein each second reactant seal comprises one second reactant seal between the first flow field plate and the membrane electrode assembly and another second reactant seal between the second flow field plate and the electrode membrane assembly.

16. An electrochemical cell as claimed in claim 15, wherein said one first and second reactant seals are integral with the first active area seal and said another first and second reactant seals are integral with the second active area seal.

17. An electrochemical cell as claimed in claim 10, wherein each of the first and second coolant seals includes a groove provided in one of the first and second flow field plates around a respective one of the first and second coolant manifold apertures, with a seal therein.

18. An electrochemical cell as claimed in claim 17, wherein each of the first and second coolant seals comprises a groove in the first flow field plate around the respective one of the first and second coolant manifold apertures and a seal therein, and a groove in the second flow field plate around a respective one of the first and second coolant manifold apertures with a seal therein.

19. An electrochemical cell as claimed in claim 15, wherein the first coolant seal comprises:
grooves around the first coolant manifold apertures, with one first coolant seal in the groove of the first flow field plate, and another first coolant seal in the groove of the second flow field plate;
wherein the second coolant seal comprises grooves in the first or second flow field plates around the second coolant manifold apertures, with one second coolant seal in the groove of the first flow field plate and another second coolant seal in the groove of the second flow field plate,
wherein the first flow field plate includes a groove for the first active area seal and the second flow field plate includes a groove for the second active area seal,
wherein said one and said another first and second coolant seals have a height higher than said one and said another first and second reactant seals, to allow for the thickness of the membrane electrode assembly.

20. An electrochemical cell as claimed in claim 19, wherein the height of the said one and said another first and second coolant seals comprises providing grooves around the first and second coolant apertures of the same depth as the grooves around the first and second reactant manifold apertures, and seals for said one and said another first and second coolant apertures with a greater height than seals around the first and second reactant manifold apertures.

21. An electrochemical cell flow field plate comprising:
a coolant manifold aperture;
an active area;
a first sealing surface groove around the coolant manifold aperture;
a second sealing surface groove around the active area;
a first seal in the first sealing surface groove, defining a first seal height in combination with the first sealing surface groove; and
a second seal in the second sealing surface groove, defining a second seal height with the second sealing surface groove, wherein the first seal height is greater than the second seal height.

22. An electrochemical cell flow field plate according to claim 21, wherein the first sealing surface groove has a shallower depth than the second sealing surface groove, and wherein the first and second seals have approximately the same thickness.

23. An electrochemical cell flow field plate according to claim 21, wherein the first sealing surface groove has approximately the same depth as the second sealing surface groove, and wherein the first seal is somewhat thicker than the second seal.

24. An electrochemical cell according to claim 22 further comprising:
a bridging seal groove, connecting the first and second sealing surface grooves, that is sloped toward the first sealing surface groove.

25. An electrochemical cell according to claim 21, wherein the first seal is formed from a material compatible with a reactant gas used in the electrochemical cell and the second seal is formed from a material compatible with a coolant to be used with the electrochemical cell.
